(19) United States
(12) Patent Application Publication
(10) Pub. No.: US 2026/0031599 A1
(43) Pub. Date: Jan. 29, 2026

(54) Flush mount distribution panel assembly

(71) Applicant: Bruce Neuschaefer, New Kensington, PA (US)

(72) Inventor: Bruce Neuschaefer, New Kensington, PA (US)

(21) Appl. No.: 18/780,765

(22) Filed: Jul. 23, 2024

(51) Int. Cl. H02B 1/056; H02B 1/40

(52) U.S. Cl. CPC H02B 1/056; H02B 1/40

(57) ABSTRACT

A flush mount distribution panel assembly includes a main body, a pair of end plates, and a cover plate. The main body includes a rear plate and a pair of side plates that are oriented facing one another and perpendicular to the rear plate. The pair of end plates are positioned to face opposite one another. Each is removably connected to a first end and a second end of the main body and includes a plurality of orifices for the passage of electrical wires and metal conduits. The cover plate includes a frame and a door pivotably attached to the frame. A plurality of connection assemblies removably connects the end plates to the rear plate and the side plates. A pair of mounting assemblies removably mounts the cover plate on the side plates to form a compartment. A circuit breaker assembly is mounted on the rear plate.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to electrical distribution panels, commonly referred to as distribution panels, and more particularly pertains to a new flush mount distribution panel assembly for facilitating installation in wall openings that have the same interior dimensions as the exterior dimensions of the distribution panel.

### (2) Description of Related Art Including Information Disclosed Under 37 CFR 1.97 and 1.98

The prior art relates to electrical distribution panels. The prior art, as best understood, does not disclose a flush mount distribution panel assembly for facilitating installation in wall openings that have the same interior dimensions as the exterior dimensions of the distribution panel, wherein flush mount distribution panel assembly includes a main body, a pair of end plates, and a cover plate, all of which are removably connectable to form a compartment.

### BRIEF SUMMARY OF THE INVENTION

When installing a distribution panel into a building, the distribution panel can be mounted free or projecting from a wall or framework. Alternatively, the distribution panel can installed flush, that is, with the cover of the distribution panel flush with the surrounding wall surfaces. To accomplish a flush installation, the distribution panel is usually connected first to the electrical wiring and then the wall is built around the distribution panel. The wall can be made from common building materials, such as wood, drywall, brick, or metal. Unfortunately, distribution panels ultimately usually need to be replaced, either due to failure, wear and tear, personal choice or need, or changes in regulatory codes for electrical wiring and distribution panels in residential and commercial buildings. For distribution panels that are not flush mounted, such replacement is quite easy because there is plenty of space to remove the old distribution panel and install a new one, even if the new distribution panel is of a different size or design. However, with a flush-mounted distribution panel, there is extremely little to no clearance between the distribution panel and the surrounding wall, which can make installation extremely difficult and result in damage to the electrical wires that have to be threaded through the top and bottom of the distribution panel. While some building materials, such as drywall, can be cut to increase the installation space and then relatively easily be repaired to re-create the flush mount, other building materials, such as brick, wood, and metal, are not readily adjustable in this manner, if at all depending on the design of the building. Even with repairable building materials like drywall, this can be time-consuming and problematic, especially for electricians installing the distribution panel who may not be as familiar with general construction, which can result in increased costs. The flush mount distribution panel assembly as disclosed in at least one possible embodiment herein permits installation into a flush mount space, either as an initial installation or as a replacement of an old distribution panel.

An embodiment of the disclosure meets the needs presented above in a flush mount distribution panel assembly generally comprising a main body, a pair of end plates, and a cover plate. The main body includes a rear plate that is rectangular and a pair of side plates that are rectangular and oriented facing one another and perpendicular to the rear plate, wherein the side plates are attached to and project from opposite sides of the rear plate. The pair of end plates are positioned to face opposite one another. Each is removably connected to a first end and a second end of the main body and includes a plurality of orifices for the passage of electrical wires and metal conduits. The cover plate includes a frame and a door pivotably attached to the frame. A plurality of connection assemblies removably connects the end plates to the rear plate and the side plates. A pair of mounting assemblies removably mounts the cover plate on the side plates to form a compartment. A circuit breaker assembly is mounted on the rear plate and within the compartment.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is an exploded view of a flush mount distribution panel assembly according to an embodiment of the disclosure.

FIG. 2 is a perspective view of an old distribution panel.

FIG. 3 is a perspective view of a first step in installing an embodiment of the disclosure.

FIG. 4 is a perspective view of a second step in installing an embodiment of the disclosure.

FIG. 5 is a perspective view of a third step in installing an embodiment of the disclosure.

FIG. 6 is a perspective view of an embodiment of the disclosure installed in a flush-mounted manner.

### DETAILED DESCRIPTION OF THE INVENTION

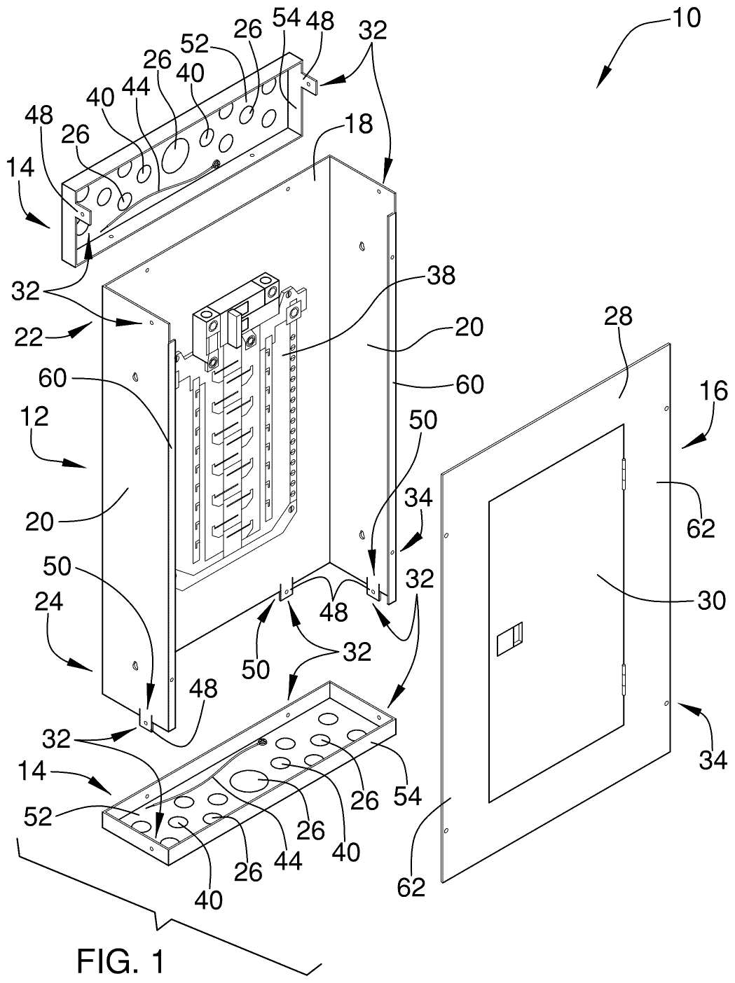

With reference now to the drawings, and in particular to FIGS. 1 through 6 thereof, a new flush mount distribution panel assembly embodying the principles and concepts of an embodiment of the disclosure and generally designated by the reference numeral 10 will be described.

As best illustrated in FIGS. 1 through 6, the flush mount distribution panel assembly 10 generally comprises a main body 12, a pair of end plates 14, and a cover plate 16. The main body 12 includes a rear plate 18 that is rectangular and a pair of side plates 20 that are rectangular and oriented facing one another and perpendicular to the rear plate 18, wherein the side plates 20 are attached to and project from opposite sides of the rear plate 18. The pair of end plates 14 are positioned to face opposite one another. Each is removably connected to a first end 22 and a second end 24 of the main body 12 and includes a plurality of orifices 26 for the passage of electrical wires 70 and metal conduits 72. The cover plate 16 includes a frame 28 and a door 30 pivotably attached to the frame 28. A plurality of connection assemblies 32 removably connects the end plates 14 to the rear plate 18 and the side plates 20. A pair of mounting assemblies 34 removably mounts the cover plate 16 on the side plates 20 to form a compartment 36. A circuit breaker assembly 38 is mounted on the rear plate 18 and within the compartment 36. Reference numerals for identical parts are not repeated in all of the figures where unnecessary for the understanding of what is shown.

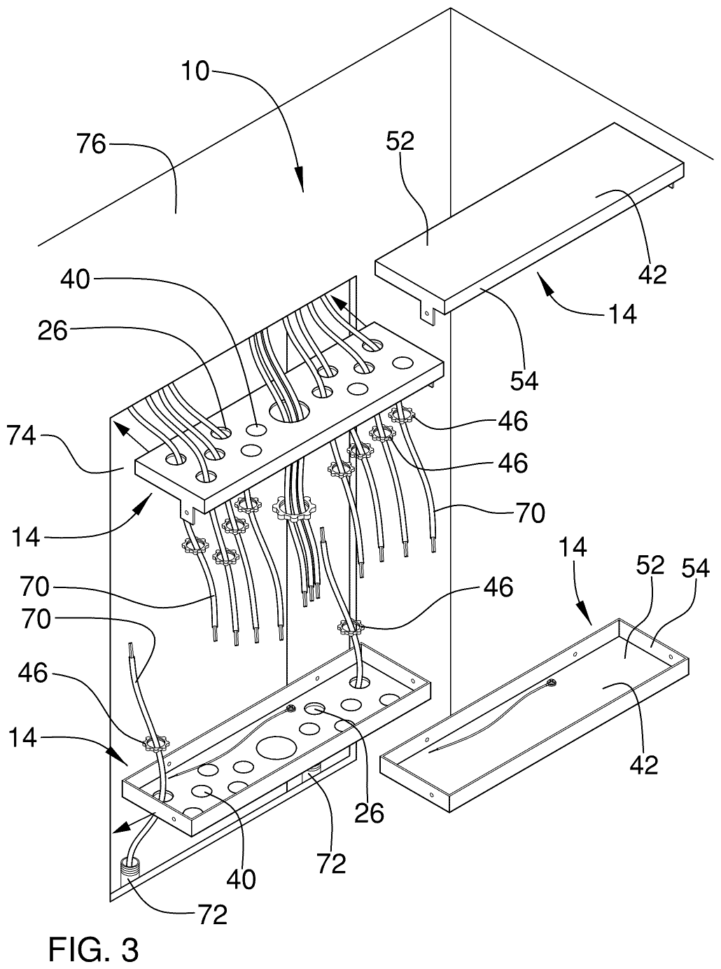

As seen in FIG. 1, each of the end plates 14 includes a plurality of removable knockouts 40, which are removed to create the orifices 26 in the end plates 14. Alternatively, as shown in FIG. 3, the end plates 14 could be solid end plates 42 without knockouts 40. Since the placement of electrical wires 70 and metal conduits 72 can vary from building to building, the solid end plates 42 would allow for customization of the location of the orifices 26, as opposed to the knockouts 40 which are pre-selected and therefore might not match a particular installation. Each of the end plates 14 also includes a ground wire 44. Since the end plates 14 are not integrally formed with the main body 12 as is usually done with distribution panels, the connection between the end panels and the main body 12 might not be electrically conductive. As such, electricity could potentially flow separately through the end plates 14, and thus additional separate ground wires 44 would be advantageous, if not necessary, for safety reasons.

In one possible embodiment, the flush mount distribution panel assembly 10 further includes a plurality of locking rings 46 designed to removably lock each of the end plates 14 to metal conduits 72 inserted through the orifices 26. While not all electrical installations utilize metal conduits 72, many do utilize them. Therefore, locking rings 46 can be used to secure the end plates 14 to these metal conduits 72.

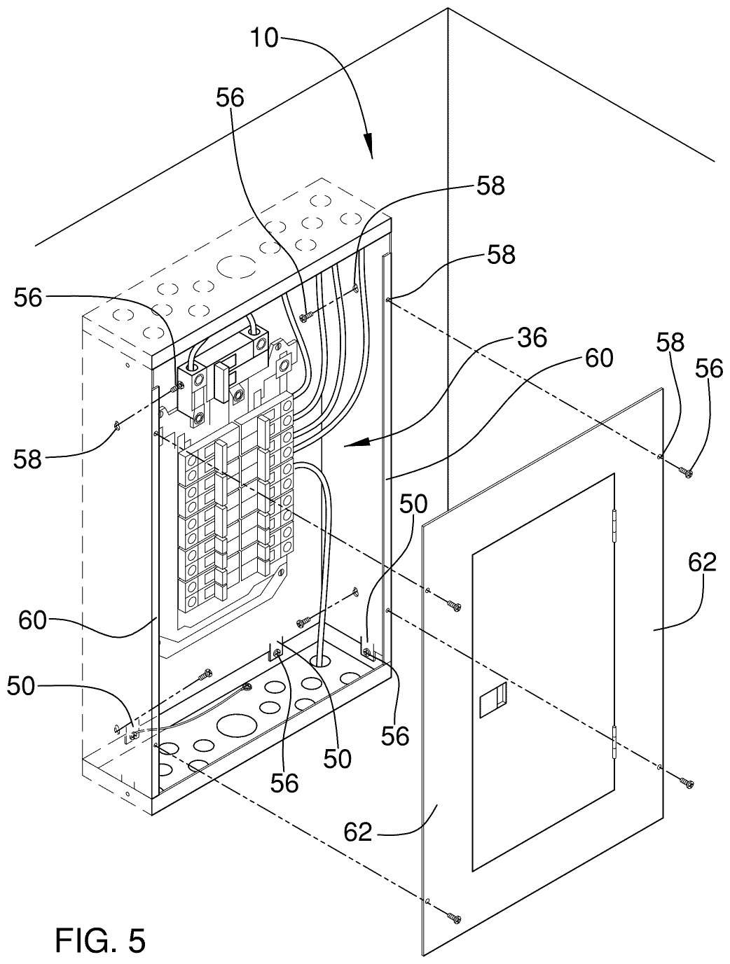

The end plates 14 can be mechanically connected to the main body 12, that is, the rear plate 18 and the side plates 20, in a variety of known manners. In the exemplary embodiment shown in the figures, each of the connection assemblies 32 includes a tab 48. The tab 48 can be positioned to overlap an adjacent section of each of the end plates 14, the rear plate 18, and the side plates 20 to align and removably connect the end plates 14 with the rear plate 18 and the side plates 20. In one possible embodiment, some of the tabs 48 are formed as cutouts 50 from surrounding portions of at least one of the end plates 14, the rear plate 18, and the side plates 20, such that the adjacent section of each of the end plates 14, the rear plate 18, and the side plates 20 is held between the tab 48 and the surrounding portions. In the exemplary embodiment shown in FIG. 5, such cutouts 50 can be seen formed in the rear plate 18 and side panels, though this is only one possible embodiment and should not be considered as limiting the disclosure or the claims.

In the exemplary embodiment shown in FIG. 1, a first plurality of the tabs 48 is attached to and projects essentially perpendicularly from a first one of the end plates 14 such that the tabs 48 overlap and frictionally engage interior surface portions of the adjacent sections of the rear plate 18 and the side plates 20 at the first end 22 of the main body 12. A second one of the end plates 14 includes a rectangular planar body 52 and side flanges 54 extending perpendicularly from outer edges of the rectangular planar body 52, though it should be noted that both of the end plates 14 in the exemplary embodiment in FIG. 1 are shown as having the side flanges 54. However, in one possible embodiment, the side flanges 54 could be omitted. A second plurality of the tabs 48 is attached to and projects essentially perpendicularly from the rear plate 18 and the side plates 20 at the second end 24 of the main body 12 such that the tabs 48 overlap and frictionally engage interior surface portions of the side flanges 54. Alternatively, in one possible embodiment, each of the tabs 48 is attached to and projects essentially perpendicularly from the end plates 14. In another possible embodiment, each of the tabs 48 is attached to and projects essentially perpendicularly from the rear plate 18 and the side plates 20.

Different common building materials could be used to connect the pieces of the flush mount distribution panel assembly 10, such as bolts, nails, and screws, though screws 56 are shown being used in the exemplary embodiment in FIGS. 1 and 3 through 6. In one possible embodiment, each of the tabs 48 includes a screw hole 58 aligned with a corresponding screw hole 58 in each of the end plates 14, the rear plate 18, and the side plates 20, and each of the connection assemblies 32 further includes a screw inserted through the screw holes 58 to removably connect the end plates 14 with the rear plate 18 and the side plates 20 and further connect the flush mount distribution panel assembly 10 to a wall structure. As shown in the exemplary embodiment in FIG. 5, the pair of mounting assemblies 34 includes a pair of flanges 60, each attached to and projecting inwardly and perpendicularly from a corresponding one of the side plates 20, and a plurality of mounting structures removably connecting side portions 62 of the frame 28 to the flanges 60. The mounting structures could be screws 56 as shown and each of the flanges 60 and the side portions 62 of the frame 28 could include aligned screw holes 58. Also as shown in FIG. 5, the main body 12 includes screw holes 58 and the flush mount distribution panel assembly 10 further includes screws 56 to removably connect the main body 12 to a wall structure.

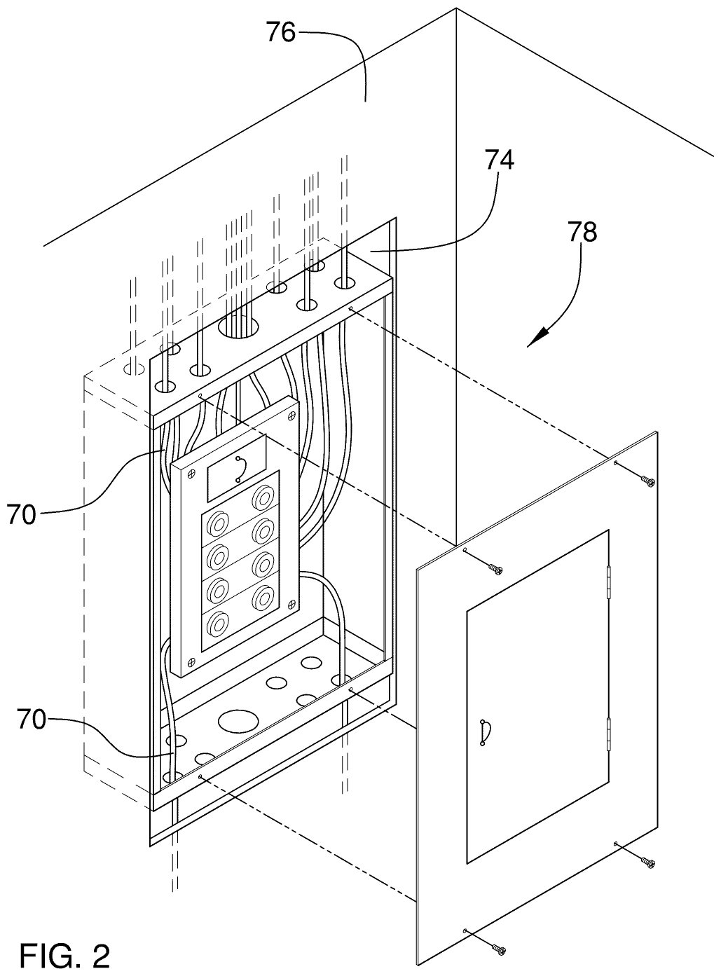

FIGS. 3 through 6 show one way to install the exemplary embodiment of the flush mount distribution panel assembly 10 into a rectangular opening 74 in a wall 76 having essentially the same interior dimensions as the outer dimensions of the flush mount distribution panel assembly 10. Before discussing the installation steps, it should be noted that FIG. 2 shows the removal of an old distribution panel 78, such as one that has failed or is no longer up to regulatory codes. FIG. 2 also shows that the rectangular opening 74 could be expanded as needed if the new flush mount distribution panel assembly 10 to be installed is larger in size, as often can be the case. However, the flush mount distribution panel assembly 10 can be installed either as an initial installation in a wall opening 74 or as a replacement, as the installation process into an wall opening 74 is the same regardless of the preceding circumstances.

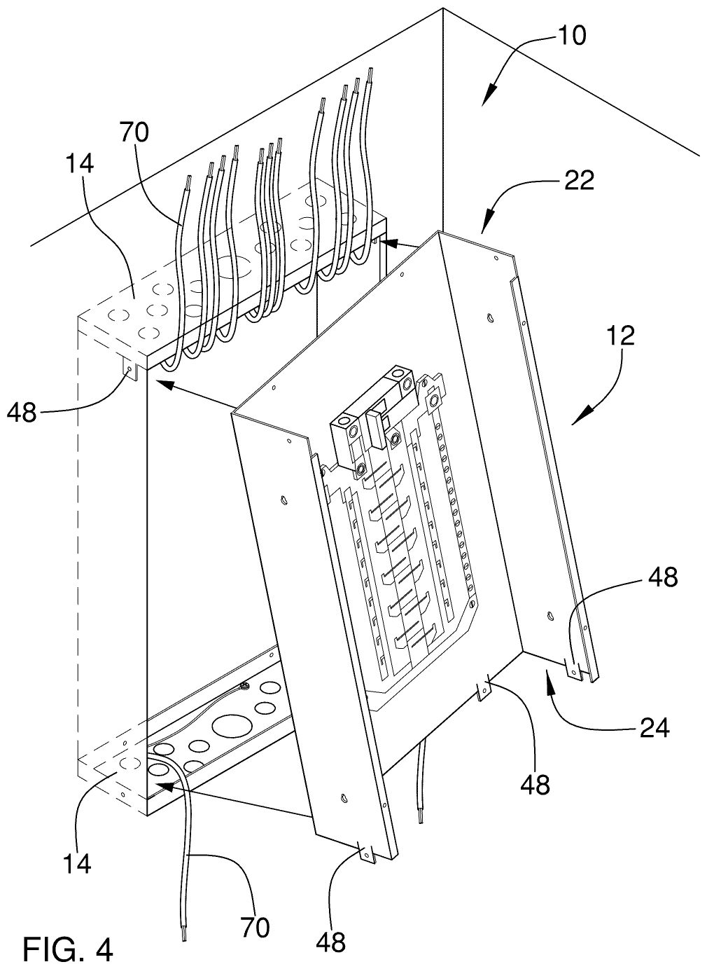

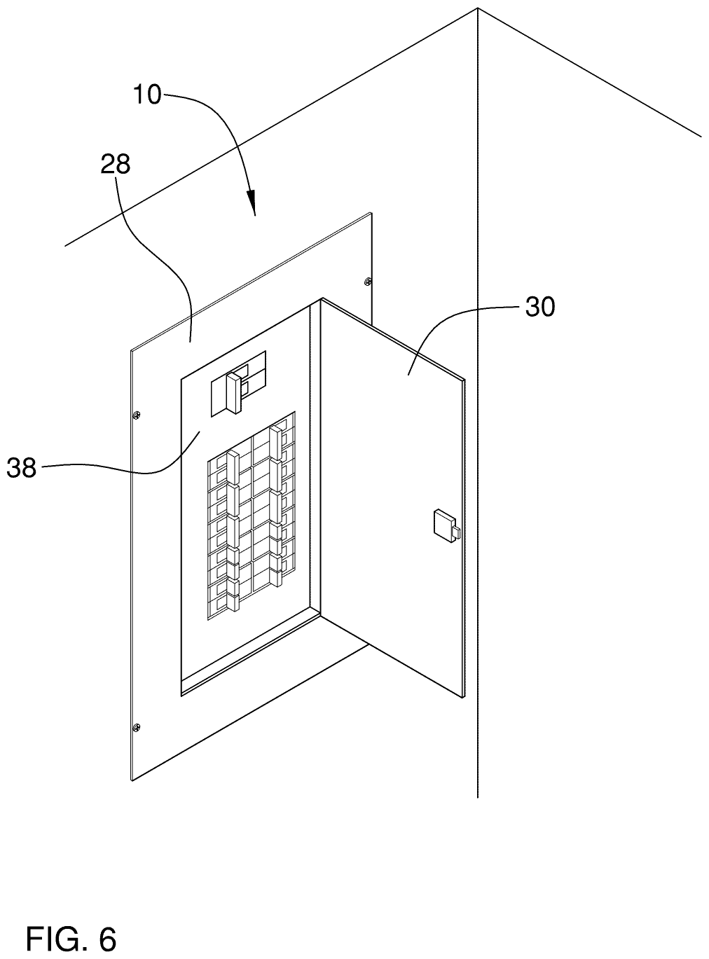

With reference to FIG. 3, the user inserts electrical wires 70 into the orifices 26 of the pair of end plates 14 and positions the end plates 14 facing opposite one another. In this example, metal conduits 72 are part of the electrical installation and thus can also be inserted through the orifices 26, and then the user can removably lock each of the end plates 14 to the metal conduits 72 with the locking rings 46. The locking rings 46 can hold the end plates 14 in place, or alternatively the user can screw the end plates 14 in place to surrounding wall 76 structure. However, the method can be performed with or without the locking rings 46. Also, as noted above, the user can use either the end plates 14 with knockouts 40 that the user can selectively remove to match the electrical installation, or the solid end plates 42 by cutting orifices 26 to match the electrical installation. With reference to FIG. 4, the user can position the electrical wires 70 inserted through the end plates 14 to project out of the rectangular opening 74 so that they are out of the way of the installation. The user then inserts the main body 12 into the rectangular opening 74 with sufficient clearance between the first end 22 and the electrical wires 70 and with sufficient clearance between the second end 24 and the electrical wires 70 to facilitate insertion of the main body 12 and minimize or prevent damage to the electrical wires 70. In the exemplary embodiment shown, the user tilts and inserts the main body 12 up into the end plate 14 at the top of the opening 74. This can be done with some overlap so that the user can then pivot the rest of the main body 12 into the opening 74 with the desired clearance. Without this clearance, the electrical wires 70 would be scraped or pinched between the edges of the main body 12 and the end plates 14. Once the main body 12 is in between the end plates 14, the main body 12 can be lowered into engagement with the end plate 14 at the bottom of the opening 74. Again, this insertion process is one possible method of insertion. Once inserted, the user can removably connect the end plates 14 to the rear plate 18 and the side plates 20 with the plurality of connection assemblies 32, such as the tabs 48 as described herein. The user then connects the electrical wires 70 to the circuit breaker assembly 38. As shown in FIG. 5, the user finally removably mounts the cover plate 16 on the side plates 20 with the pair of mounting assemblies 34 to form a compartment 36, wherein the cover plate 16 is flush with surrounding wall 76 surfaces, as shown in FIG. 6.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A flush mount distribution panel assembly comprising:
a main body comprising a rear plate that is rectangular and a pair of side plates that are rectangular and oriented facing one another and perpendicular to said rear plate, wherein said side plates are attached to and project from opposite sides of said rear plate;
a pair of end plates disposed to face opposite one another and being removably connected to a first end and a second end of said main body and comprising a plurality of orifices for the passage of electrical wires and metal conduits;
a cover plate comprising a frame and a door pivotably attached to said frame;
a plurality of connection assemblies removably connecting said end plates to said rear plate and said side plates;
a pair of mounting assemblies removably mounting said cover plate on said side plates to form a compartment; and
a circuit breaker assembly mounted on said rear plate and within said compartment.

2. The flush mount distribution panel assembly of claim 1, wherein each of said end plates comprises a ground wire.

3. The flush mount distribution panel assembly of claim 1, wherein each of said end plates comprises a plurality of removable knockouts.

4. The flush mount distribution panel assembly of claim 1, wherein the flush mount distribution panel assembly further comprises a plurality of locking rings configured to removably lock each of said end plates to metal conduits inserted through said orifices.

5. The flush mount distribution panel assembly of claim 1, wherein each of said connection assemblies comprises a tab overlapping an adjacent section of each of said end plates, said rear plate, and said side plates to align and removably connect said end plates with said rear plate and said side plates.

6. The flush mount distribution panel assembly of claim 5, wherein a portion of said tabs are formed as cutouts from surrounding portions of at least one of said end plates, said rear plate, and said side plates, such that said adjacent section of each of said end plates, said rear plate, and said side plates is held between said tab and said surrounding portions.

7. The flush mount distribution panel assembly of claim 5, wherein each of said tabs comprises a screw hole aligned with a corresponding screw hole in each of said end plates, said rear plate, and said side plates, and each of said connection assemblies further comprises a screw inserted through said screw holes to removably connect said end plates with said rear plate and said side plates and further connect the flush mount distribution panel assembly to a wall structure.

8. The flush mount distribution panel assembly of claim 5, wherein each of said tabs is attached to and projects essentially perpendicularly from said end plates such that said tabs overlap and frictionally engage interior surface portions of said adjacent sections of said rear plate and said side plates.

9. The flush mount distribution panel assembly of claim 5, wherein each of said end plates comprises a rectangular planar body and side flanges extending perpendicularly from outer edges of said rectangular planar body, and each of said tabs is attached to and projects essentially perpendicularly from said rear plate and said side plates such that said tabs overlap and frictionally engage interior surface portions of said side flanges.

10. The flush mount distribution panel assembly of claim 5, wherein:
a first plurality of said tabs is attached to and projects essentially perpendicularly from a first one of said end plates such that said tabs overlap and frictionally engage interior surface portions of said adjacent sections of said rear plate and said side plates at said first end of said main body;
a second one of said end plates comprises a rectangular planar body and side flanges extending perpendicularly from outer edges of said rectangular planar body; and
a second plurality of said tabs is attached to and projects essentially perpendicularly from said rear plate and said side plates at said second end of said main body such that said tabs overlap and frictionally engage interior surface portions of said side flanges.

11. The flush mount distribution panel assembly of claim 1, wherein said pair of mounting assemblies comprises a pair of flanges, each attached to and projecting inwardly and perpendicularly from a corresponding one of said side plates, and a plurality of mounting structures removably connecting side portions of said frame to said flanges.

12. The flush mount distribution panel assembly of claim 11, wherein said mounting structures comprise screws and each of said flanges and said side portions of said frame comprises aligned screw holes.

13. The flush mount distribution panel assembly of claim 1, wherein said main body comprises screw holes and the flush mount distribution panel assembly further comprises screws to removably connect said main body to a wall structure.

14. A method of installing the flush mount distribution panel assembly of claim 1 into a rectangular opening in a wall having essentially the same interior dimensions as the outer dimensions of the flush mount distribution panel assembly, comprising the steps of:
inserting electrical wires into orifices of said pair of end plates and positioning said end plates facing opposite one another;
positioning the electrical wires inserted through said end plates to project out of the rectangular opening;
inserting said main body into the rectangular opening with sufficient clearance between said first end and the electrical wires and with sufficient clearance between said second end and the electrical wires to facilitate insertion of said main body and minimize or prevent damage to the electrical wires,
removably connecting said end plates to said rear plate and said side plates with said plurality of connection assemblies;
connecting the electrical wires to said circuit breaker assembly; and
removably mounting said cover plate on said side plates with said pair of mounting assemblies to form a compartment, wherein said cover plate is flush with surrounding wall surfaces.

15. The method of claim 14, wherein the flush mount distribution panel assembly further comprises a plurality of locking rings configured to removably lock each of said end plates to metal conduits inserted through said orifices, and said method further comprises inserting metal conduits into said orifices of said pair of end plates and removably locking each of said end plates to said metal conduits.

16. A flush mount distribution panel assembly comprising:
a main body comprising a rear plate that is rectangular and a pair of side plates that are rectangular and oriented facing one another and perpendicular to said rear plate, wherein said side plates are attached to and project from opposite sides of said rear plate;
a pair of end plates disposed to face opposite one another and being removably connected to a first end and a second end of said main body and comprising a plurality of orifices for the passage of electrical wires and metal conduits, wherein:
each of said end plates comprises a plurality of removable knockouts,
each of said end plates comprises a ground wire,
the flush mount distribution panel assembly further comprises a plurality of locking rings configured to removably lock each of said end plates to metal conduits inserted through said orifices;
a cover plate comprising a frame and a door pivotably attached to said frame;
a plurality of connection assemblies removably connecting said end plates to said rear plate and said side plates, wherein:
each of said connection assemblies comprises a tab overlapping an adjacent section of each of said end plates, said rear plate, and said side plates to align and removably connect said end plates with said rear plate and said side plates,
a portion of said tabs are formed as cutouts from surrounding portions of at least one of said end plates, said rear plate, and said side plates, such that said adjacent section of each of said end plates, said rear plate, and said side plates is held between said tab and said surrounding portions;
a pair of mounting assemblies removably mounting said cover plate on said side plates to form a compartment, wherein:
said pair of mounting assemblies comprises a pair of flanges, each attached to and projecting inwardly and perpendicularly from a corresponding one of said side plates, and a plurality of mounting structures removably connecting side portions of said frame to said flanges; and
a circuit breaker assembly mounted on said rear plate and within said compartment.

17. The flush mount distribution panel assembly of claim 16, wherein each of said tabs is attached to and projects essentially perpendicularly from said end plates such that said tabs overlap and frictionally engage interior surface portions of said adjacent sections of said rear plate and said side plates.

18. The flush mount distribution panel assembly of claim 16, wherein each of said end plates comprises a rectangular planar body and side flanges extending perpendicularly from outer edges of said rectangular planar body, and each of said tabs is attached to and projects essentially perpendicularly from said rear plate and said side plates such that said tabs overlap and frictionally engage interior surface portions of said side flanges.

19. The flush mount distribution panel assembly of claim 16, wherein:
a first plurality of said tabs is attached to and projects essentially perpendicularly from a first one of said end plates such that said tabs overlap and frictionally engage interior surface portions of said adjacent sections of said rear plate and said side plates at said first end of said main body;
a second one of said end plates comprises a rectangular planar body and side flanges extending perpendicularly from outer edges of said rectangular planar body; and
a second plurality of said tabs is attached to and projects essentially perpendicularly from said rear plate and said side plates at said second end of said main body such that said tabs overlap and frictionally engage interior surface portions of said side flanges.

20. The flush mount distribution panel assembly of claim 16, wherein:
each of said tabs comprises a screw hole aligned with a corresponding screw hole in each of said end plates, said rear plate, and said side plates, and each of said connection assemblies further comprises a screw inserted through said screw holes to removably connect said end plates with said rear plate and said side plates and further connect the flush mount distribution panel assembly to a wall structure;
said mounting structures comprise screws and each of said flanges and said side portions of said frame comprises aligned screw holes; and
said main body comprises screw holes and the flush mount distribution panel assembly further comprises screws to removably connect said main body to a wall structure.
